(19) United States
(12) Patent Application Publication
(10) Pub. No.: US 2026/0300325 A1
(43) Pub. Date: Oct. 1, 2026

(54) ENABLING SEMANTIC QUERIES IN RELATIONAL DATABASES CONTAINING FREE-FORM TEXT

(71) Applicant: INTERNATIONAL BUSINESS MACHINES CORPORATION, Armonk, NY (US)

(72) Inventors: Bulent Abali, Tenafly, NJ (US); Rajesh Bordawekar, Westchester, NY (US)

(21) Appl. No.: 19/091,307

(22) Filed: Mar. 26, 2025

(51) Int. Cl. G06F 16/28; G06F 16/22; G06N 20/00

(52) U.S. Cl. CPC G06F 16/288; G06F 16/2237; G06F 16/285; G06N 20/00

(57) ABSTRACT

Systems, methods, and computer program products for training a machine learning model are disclosed. A method may comprise accessing a relational database comprising a first table, the first table comprising an array of entries, wherein each entry is associated with a record; providing the plurality of entries as input to an encoder model; reading a plurality of embeddings generated by the encoder model based on the input thereto such that an embedding characterizing each entry is read; identifying an array of labels based on the plurality of embeddings, wherein the array of labels comprises a label for each entry; generating a training relational database based on the relational database and the identified labels, the training relational database comprising a second table, the second table comprising the array of entries and the array of labels; and training a first machine learning model based on at least the training relational database.

### BACKGROUND

Embodiments of the present disclosure relate to relational databases, and more specifically, to enabling semantic queries in relational databases containing free-form text.

### BRIEF SUMMARY

According to embodiments of the present disclosure, systems, methods of, and computer program products for training a machine learning model are disclosed. According to one or more embodiments of the present disclosure, a relational database is accessed. The relational database may comprise a first table. The first table may comprise an array of entries. Each entry may be associated with a record. The plurality of entries may be provided as input to an encoder model. A plurality of embeddings generated by the encoder model may be read. The plurality of embeddings may have been generated based on the input to the encoder model. An array of labels may be identified based on the plurality of embeddings. The array of labels may comprise a label for each entry. A training relational database may be generated. The training relational database may be generated based on the relational database and the identified labels. The training relational database may comprise a second table. The second table may comprise the array of entries and the array of labels. A first machine learning model may be trained based on at least the training relational database.

### BRIEF DESCRIPTION OF THE DRAWINGS

FIG. 1 is a flow diagram depicting an exemplary method for training a machine learning model, in accordance with one or more embodiments of this disclosure.

FIG. 2 is an exemplary table of a relational database, in accordance with one or more embodiments of this disclosure.

FIG. 3 is a flow diagram depicting an exemplary method for generating a response to a database query, in accordance with one or more embodiments of this disclosure.

FIG. 4 depicts a computing node according to one or more embodiments of the present disclosure.

### DETAILED DESCRIPTION

AI-powered Databases use self-supervised training to build a semantic model from multi-modal relational tables. AI-powered databases generally enable a new class of semantic SQL cognitive intelligence (CI) queries. However, the semantic CI queries are limited to structured data entries. Various embodiments described herein comprises training a semantic model to enable semantic CI queries for databases with unstructured data entries.

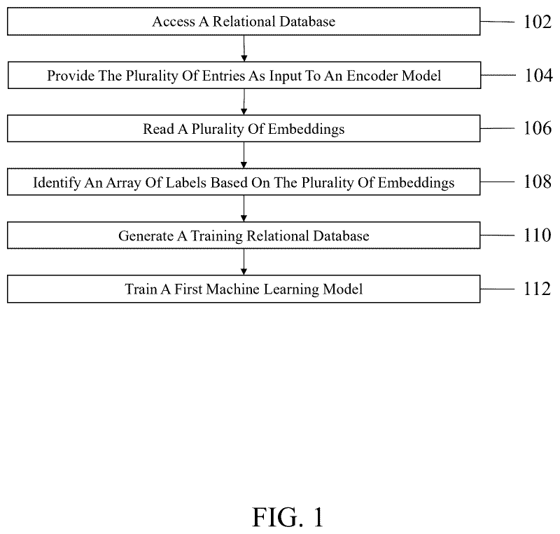

Referring now to FIG. 1 a flowchart illustrating an exemplary method 100 for training a machine learning model is depicted. The operations of method 100 presented below are intended to be illustrative. In some implementations, method 100 is accomplished with one or more additional operations not described and/or without one or more of the operations discussed. The operations of method 100 may be performed in another order. Additionally, the order in which the operations of method 100 are illustrated in FIG. 1 and described below is not intended to be limiting.

In some implementations, method 100 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 100.

Operation 102 may comprise accessing a relational database comprising a first table, the first table comprising an array of entries. Each entry may be associated with a record. The relational database may be configured to store and/or manage data in a subject domain. Each entry may comprise one or more of free text, an audio file, a pdf file, an image, and/or another format. For example, each entry may be unstructured. An unstructured entry may comprise data that does not follow a predefined format. A structured entry may follow a predefined format. For example, the first table may comprise a second array of entries. The entries of the second array may represent dates. Each date may represented by the same format (e.g., “MM/YY”). Accordingly, the second array of entries may follow a predetermined format, and the entries of the second array may be structured.

Operation 104 may comprise providing the plurality of entries as input to at least one encoder model. In some implementations, the plurality of entries are provided as input to an audio-visual encoder model. The audio-visual encoder model may be a trained machine learning model for audio classification, speech recognition, image classification, object detection, video classification, and/or image-to-text conversion. By way of non-limiting example, the audio-visual encoder model is configured to receive an unstructured data type as input. The audio-visual encoder model may be configured to generate text characterizing the input thereto.

In some implementations, operation 104 may comprise providing text as input to an encoder model. For example, the text generated by the audio-visual encoder model is provided as input to the encoder model. For example, each entry is provided as input to the encoder model. In some implementations, the encoder model is a general purpose encoder model. The encoder model may be pre-trained using data in the subject domain. For example, the encoder model was pretrained based on IBM RedBooks. For example, the encoder model is BERT: all-miniLM-L6-2, all-mpnet-base-v2, and/or another model. The encoder model may be a and/or may be derived from a large language model. The encoder model may be configured to take text as input and generate a characterization of the input thereto. For example, the characterization is not unique.

Operation 106 may comprise reading a plurality of embeddings generated by the encoder model based on the input thereto. An embedding characterizing each entry may be read. For example, each embedding characterizes the semantic meaning of an associated entry

Operation 108 may comprise identifying an array of labels based on the plurality of embeddings. The array of labels may comprise a label for each entry. Identifying the labels may comprise clustering and/or classifying the entries. Method 100 may comprise assigning each entry to a cluster of a plurality of clusters of entries. The assignment may be based on the plurality of embeddings. The label identified for an entry may identify the cluster assigned for that entry. Identifying the array of labels may comprise selecting a label for each entry from a plurality of labels. For example, the labels have a semantic meaning. Each label may identify a classification.

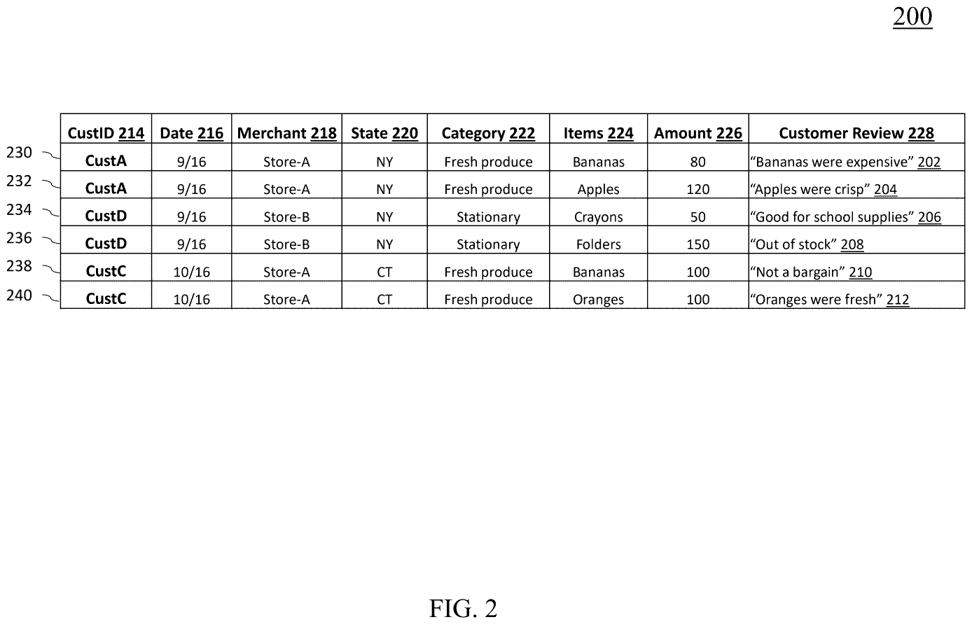

Referring now to FIG. 2, an exemplary table 200 of a relational database is depicted. Table 200 comprises arrays 214, 216, 218, 220, 222, 224, 226, and 228. Table 200 comprises records 230, 232, 234, 236, 238, and 240. Array 228 comprises reviews 202, 204, 206, 208, 210, and 212. Reviews 202, 204, 206, 208, 210, and 212 are respectively associated with records 230, 232, 234, 236, 238, and 240. Each review 202-212 may be a free-text entry of table 200. In some implementations, the reviews of array 228 are clustered and/or classified.

Reviews 202-212 may be clustered and/or classified based on the semantic meaning of the reviews. For example, the reviews are classified into a negative class and a positive class. In such an example, the negative class comprises reviews having a negative sentiment, and the positive class comprises reviews having a positive sentiment. The positive class comprises reviews 202, 208, and 210. The negative class comprises reviews 204, 206, and 212.

In another example, the reviews are classified based on a topic of the reviews. In such an example, the reviews are classified into a price class, a grocery class, an availability class, and a stationary class. The price class may comprise reviews 202 and/or 210. The grocery class may comprise one or more of reviews 202, 204, and 212. The availability class may comprise review 208. The stationary class may comprise review 206. Each review may be assigned to one or more classes. In some implementations, review 202 is assigned to the price class by virtue of its semantic meaning relating to the price of an item. In some implementations, review 202 is assigned to the grocery class by virtue of its semantic meaning relating to a produce item. For example, classifying reviews 202-212 comprises selecting a label for each entry. The label may be selected from a plurality of labels. For example, the plurality of labels comprises “price,” “grocery,” “availability,” and “stationary.”

In yet another example, the reviews are clustered. Reviews 202 and 210 may be clustered into a first cluster. Reviews 204 and 212 may be clustered into a second cluster. Review 208 may be clustered into a third cluster. Review 206 may be clustered into a fourth cluster. By way of non-limiting example, the first cluster and the second cluster may be near each other within an embedding space.

Referring back to FIG. 1, operation 110 may comprise generating a training relational database. The training relational database may be generated based on one or more of the relational database, the identified labels, and/or other information. The training relational database may comprise a second table. The second table may comprise the array of entries and the array of labels.

Operation 112 may comprise training a first machine learning model. The first machine learning model may be based on at least the training relational database. In some implementations, the first machine learning model is a vector space model. Training the first machine learning model may comprise generating a unique characterization for each entry. For example, a first characterization is generated for a first entry associated with a first record. The first characterization may be generated based on the first entry, one or more other entries associated with the first record, and/or other information.

In some implementations, method 100 comprises reading a natural language prompt and/or a code segment characterizing at least one database operation. The natural language prompt may be embedded within a database query. For example, the code segment may comprise a natural language prompt. For example, the code segment is in a database programming language (e.g., SQL). Method 100 may comprise providing the natural language prompt as input to at least a second machine learning model. Method 100 may comprise reading a database operation for the relational database. In some implementations, the database operation is read from the at least second machine learning model. Method 100 may comprise performing the database operation using at least the first machine learning model.

For example, the natural language prompt is “Customers complaining about grocery quality, price, or availability.” For example, an exemplary database query for table 200 of FIG. 2 is as follows:

SELECT DISTINCT
AI_SIMILARITY(‘Customers complaining about grocery quality, price,
or availability’ USING MODEL COLUMN Customer_Review)
AS SimilarityScore, X.*
FROM SALES_DATA X
WHERE X.State = ‘NY’
ORDER BY SimilarityScore
FETCH FIRST 15 ROWS ONLY

For example, the exemplary database query comprises a database operation to determine a similarity score for each customer review of array 228 depicted in FIG. 2. For example, the natural language prompt of the query may be provided as input to a second machine learning model. The second machine learning model may be the same as or similar to the first machine learning model, the encoder model, a language model, and/or another machine learning model. The second machine learning model may be configured to characterize the natural language prompt. For example, the second machine learning model is configured to generate an embedding characterizing the natural language prompt. For example, the characterization of the natural language prompt is in the same vector same as the unique characterizations of the entries. For example, determining the similarity scores comprises comparing the characterization of the natural language prompt to each unique characterization.

In some implementations, the database operation is based on and/or related to the label associated with each entry. For example, the exemplary natural language prompt is related to the “positive” and “negative” labels. For example, the exemplary natural language prompt is related to the “price,” “grocery,” “availability,” and “stationary” labels. Performing the database operation may be based on at least the array of labels.

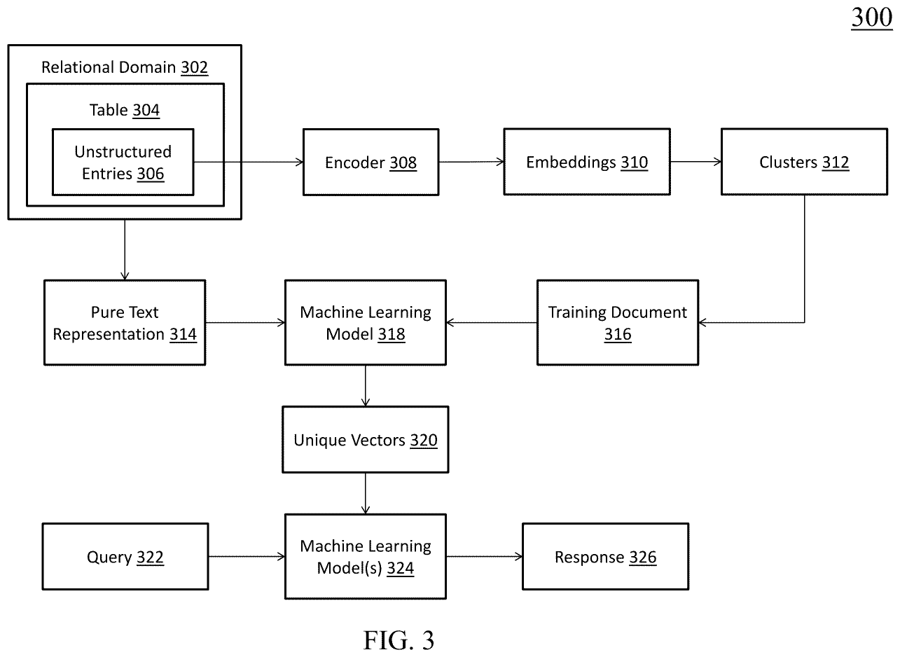

Referring now to FIG. 3, a method 300 of generating responses to database queries. A database query is a request to access, manipulate, delete, or retrieve data from a relational database. Method 300 may comprise reading a relational domain 302. Relational domain 302 may be or may comprise a relational database. Relational domain 302 comprises table 304. Table 304 may comprise a plurality of rows and a plurality of columns. Each row may be associated with a record. Each column may be associated with a field of data stored and/or managed by relational domain 302. By way of non-limiting example, each field is associated with structured data or unstructured data. Table 304 may comprise a plurality of entries. Each entry is associated with a record and a field. The plurality of entries may comprise unstructured entries 306. For example, unstructured entries 306 are associated with a field of table 304. Unstructured entries 306 may be provided as input to encoder model 308. Encoder model 308 may be configured to generate embeddings characterizing semantic meaning of the input thereto. Embeddings 310 may be read from encoder 308. Each embedding 310 may characterize an unstructured entry 306. Each embedding 310 may be a vector embedding.

Embeddings 310 may be clustered and/or classified. Each cluster may be associated with a classification. Embeddings 310 may be clustered using k-means clustering, hierarchical clustering, density-based clustering, spectral clustering, fuzzy clustering, model-based clustering, and/or another clustering method. Embeddings 310 may be classified using linear discriminant analysis, support vector machines, k-nearest neighbors, decision trees, random forests, neural networks, logistic regression, naive Bayes classification, and/or another classification method. For example, embeddings 310 are organized into a plurality of clusters 312. Each cluster 312 may be identified by a label having semantic meaning and/or by a cluster label. Each record may be associated with a cluster 312 based on said organization. For example, a first embedding 310 for a first unstructured entry 306 of a first record is generated. First embedding 310 may be organized into a first cluster 312. Accordingly, the first record is associated with first cluster 312.

Training document 316 may be generated. Training document 316 may comprise table 304. Training document 316 may comprise a training table. For example, the training table is table 304 with an additional column comprising the labels for the clusters associated with each record. For example, the training table comprises first unstructured entry 306 and the label for first cluster 312.

Pure text representation 314 may be generated. Pure text representation 314 may be a representation of table 304, relational domain 302, and/or training document 316. Pure text representation 314 may comprise only plain characters to describe the structure and content of table 304, relational domain 302, and/or training document 316. In some implementations, pure text representation 314 is a text-only, or pure text representation of table 304, relational domain 302, and/or training document 316. Pure text representation 314 may comprise only characters of readable material, without any formatting or structural information. Pure text representation 314 may comprise each entry of table 304. For example, pure text representation 314 is generated using a format such as CSV, fixed-width, or another format.

Machine learning model 318 may be trained. Said training may be based on training information. The training information may comprise pure text representation 314, training document 316, relational domain 302, a text corpus, and/or other information. The text corpus may be derived from a public corpus (e.g., Wikipedia). For example, the For example, training machine learning model 318 may comprise tokenizing the training information. For example, machine learning model 318 is trained using unsupervised learning, semi-supervised learning, or supervised learning. Machine learning model 318 may be configured to generate embeddings characterizing input thereto. Machine learning model 318 may be configured to generate vectors characterizing unstructured entries 306 and/or vectors characterizing records of table 304. Similarity between vectors generated by machine learning model 318 may represent similarity between the entries or records characterized by the vectors.

Unique vectors 320 may be read from machine learning model 318. For example, machine learning model 318 is configured to generate unique vectors for unique input thereto. Each unique vector 320 may characterize an unstructured entry 306. A query 322 may be read. Query 322 may comprise a query language code segment and/or a natural language prompt. For example, query 322 is received from a client computing platform associated with a user. Query 322, unique vectors 320, and/or other information may be provided as input to one or more machine learning models 324. One or more machine learning models 326 may be configured to generate a response 326 to query 322. Query 322 may be a cognitive intelligence query. Cognitive intelligence queries use at least one machine learning model 324 to answer structured query language (SQL) queries pertaining to structured data source(s) 106, such as in relational tables.

In some implementations, response 326 is generated without the use of a machine learning model. For example, generating response 326 comprises comparing two or more unique vectors 320 and/or two or more entries of table 304. Said comparison may comprise determining a cosine similarity, a Euclidean distance, a Jaccard index, a Pearson correlation, a Hamming distance, and/or another similarity metric. In some implementations, response 326 is returned as a structured result (e.g., a relational table), one or more entries of relational domain, and/or a characterization of other information derived based on relational domain 302. Response 326 may be a modification to relational domain 302.

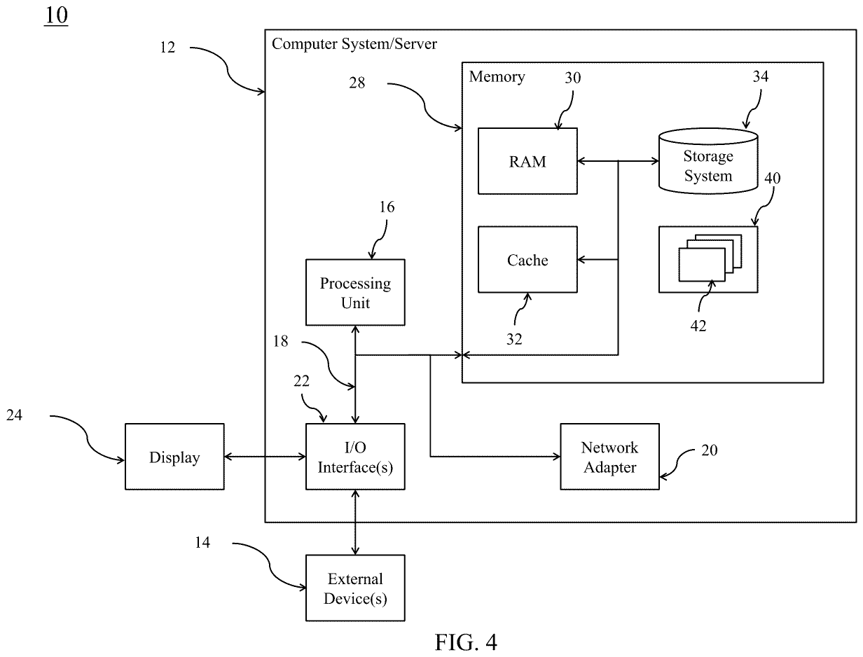

As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In various embodiments, a vector of features that includes the machine learning model input(s) may be provided to one or more of the machine learning models described herein. Based on the input features, one or more of the machine learning models described herein may generate one or more outputs. In some embodiments, the output(s) of the one or more machine learning models described herein may be a vector of features.

In various embodiments, the one or more machine learning models, described herein, may be pre-trained using training data. In various embodiments training data may be retrospective data. In various embodiments, the retrospective data may be stored in a datastore. In various embodiments, the one or more machine learning models, described herein, may be additionally trained through manual curation of previously generated outputs.

In various embodiments, the one or more machine learning models, described herein, may be and/or may include a dynamic programming algorithm and/or model, such as a dynamic linear programming algorithm/model or a dynamic nonlinear programming algorithm/model. In various embodiments, the one or more machine learning models, described herein, may be a trained classifier. In various embodiments, the trained classifier may be a random decision forest. However, it will be appreciated that a variety of other classifiers are suitable for use according to the present disclosure, including linear classifiers, support vector machines (SVM), or artificial neural network models, such as generative adversarial networks (GANs), a long short-term memory (LSTM) model, and/or recurrent neural networks (RNNs).

Suitable artificial neural network models include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, a transformer, or a deep Q-network.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method of training a machine learning model, the method comprising:
accessing a relational database comprising a first table, the first table comprising an array of entries, wherein each entry is associated with a record;
providing the array of entries as input to an encoder model;
reading a plurality of embeddings generated by the encoder model based on the input thereto such that an embedding characterizing each entry is read;
identifying an array of labels based on the plurality of embeddings, wherein the array of labels comprises a label for each entry;
generating a training relational database based on the relational database and the array of labels, wherein the training relational database comprises a second table, wherein the second table comprises the array of entries and the array of labels;
training a first machine learning model based on at least the training relational database;
reading a query for the relational database, wherein the query comprises at least one of a query language code segment and a natural language prompt characterizing a database operation;
performing the database operation using at least the first machine learning model; and
returning a response to the query as a structured result.

2. The method of claim 1, wherein the relational database is configured to store and manage data in a subject domain, wherein the encoder model is pre-trained using data in the subject domain.

3. The method of claim 1, the method further comprising:
assigning, based on the plurality of embeddings, each entry to a cluster of a plurality of clusters of entries, and wherein
the label for that entry identifies the cluster assigned for that entry.

4. The method of claim 1, wherein said identifying of the array of labels comprises selecting a label for each entry from a plurality of labels based on the plurality of embeddings.

5. The method of claim 1, wherein the first machine learning model is a vector space model.

6. The method of claim 1, wherein said training comprises generating a unique characterization for each entry.

7. The method of claim 1, the method further comprising:
reading a database operation for the relational database; and
performing the database operation using at least the first machine learning model.

8. The method of claim 7, the method further comprising:
reading a natural language prompt characterizing the database operation; and
providing the natural language prompt as input to at least a second machine learning model, and wherein
said reading of the database operation is from the at least second machine learning model.

9. The method of claim 7, wherein the database operation is based on the label associated with each entry, wherein said performing of the database operation is based on at least the array of labels.

10. The method of claim 1, wherein each entry comprises one or more of free text, an audio file, a pdf file, and an image.

11. A computer program product comprising:
one or more computer-readable storage media; and
program instructions stored on the one or more computer-readable storage media to perform operations comprising:
accessing a relational database comprising a first table, the first table comprising an array of entries, wherein each entry is associated with a record;
providing the array of entries as input to an encoder model;
reading a plurality of embeddings generated by the encoder model based on the input thereto such that an embedding characterizing each entry is read;
identifying an array of labels based on the plurality of embeddings, wherein the array of labels comprises a label for each entry;
generating a training relational database based on the relational database and the array of labels, wherein the training relational database comprises a second table, wherein the second table comprises the array of entries and the array of labels;
training a first machine learning model based on at least the training relational database;
reading a query for the relational database, wherein the query comprises at least one of a query language code segment and a natural language prompt characterizing a database operation;
performing the database operation using at least the first machine learning model; and
returning a response to the query as a structured result.

12. The computer program product of claim 11, the operations further comprising:
assigning, based on the plurality of embeddings, each entry to a cluster of a plurality of clusters of entries, and wherein
the label for that entry identifies the cluster assigned for that entry.

13. The computer program product of claim 11, wherein said identifying of the array of labels comprises selecting a label for each entry from a plurality of labels based on the plurality of embeddings.

14. The computer program product of claim 11, wherein the first machine learning model is a vector space model.

15. The computer program product of claim 11, wherein said training comprises generating a unique characterization for each entry.

16. A computer system comprising:
a processor set;
one or more computer-readable storage media; and
program instructions stored on the one or more computer-readable storage media to perform operations comprising:
accessing a relational database comprising a first table, the first table comprising an array of entries, wherein each entry is associated with a record;
providing the array of entries as input to an encoder model;
reading a plurality of embeddings generated by the encoder model based on the input thereto such that an embedding characterizing each entry is read;
identifying an array of labels based on the plurality of embeddings, wherein the array of labels comprises a label for each entry;
generating a training relational database based on the relational database and the array of labels, wherein the training relational database comprises a second table, wherein the second table comprises the array of entries and the array of labels;
training a first machine learning model based on at least the training relational database;
reading a query for the relational database, wherein the query comprises at least one of a query language code segment and a natural language prompt characterizing a database operation;
performing the database operation using at least the first machine learning model; and
returning a response to the query as a structured result.

17. The computer system of claim 16, the operations further comprising:
assigning, based on the plurality of embeddings, each entry to a cluster of a plurality of clusters of entries, and wherein
the label for that entry identifies the cluster assigned for that entry.

18. The computer system of claim 16, wherein said identifying of the array of labels comprises selecting a label for each entry from a plurality of labels based on the plurality of embeddings.

19. The computer system of claim 16, wherein the first machine learning model is a vector space model.

20. The computer system of claim 16, wherein said training comprises generating a unique characterization for each entry.
